(19) United States
(12) Patent Application Publication
(10) Pub. No.: US 2025/0058440 A1
(43) Pub. Date: Feb. 20, 2025

(54) HYDRAULIC TORQUE WRENCH

(71) Applicant: ATLAS COPCO INDUSTRIAL TECHNIQUE AB, Stockholm (SE)

(72) Inventors: Ian O'BRIEN, Cramlington Northumberland (GB); Joseph GILL, Cramlington Northumberland (GB); Tony DODDS, Cramlington Northumberland (GB); Teresa O'BRIEN, Cramlington Northumberland (GB)

(21) Appl. No.: 18/720,127

(22) PCT Filed: Dec. 14, 2022
(86) PCT No.: PCT/IB2022/062230

§ 371 Date: Jun. 14, 2024

(30) Foreign Application Priority Data
Dec. 15, 2021 (GB) 2118145.8

(51) Int. Cl. B25B 23/145; B25B 21/00

(52) U.S. Cl. CPC B25B 23/145; B25B 21/005

(57) ABSTRACT

A hydraulic torque wrench (10) comprising: a housing (12); a drive pawl (1), pivotally mounted in the housing (12); and a piston rod (2), configured to be driven and connected to the drive pawl (1) in order to drive the drive pawl (1). A ratchet gear (3), configured to be driven for rotation by the drive pawl (1). A spring (4), configured to bias the drive pawl (1) into engagement with the ratchet gear (3). A travel limiter arranged to limit a pivoting travel of the drive pawl (1) away from engagement with the ratchet gear (3). By limiting the travel of the drive pawl (1), we remove the risk of over-extension of the spring (3).

This disclosure relates to a hydraulic torque wrench.

Hydraulic wrenches are well known in the prior art, from as an example WO2018/130854. Atlas Copco provides a hydraulic torque wrench, as do other suppliers, which comprise a releasable drive (typically a square drive, although a differently-shaped drive, e.g. a hexagon drive or a socket drive, may be used). One or more drive sleeves may be used to assist with insertion and/or positioning of the drive. One or more releasable retainers may be used to retain the drive.

Generally, such tools comprise a ratchet mechanism which is repeatedly driven by a hydraulic cylinder with linear drive and retraction strokes. The ratchet mechanism ensures that the drive rotates in only one sense. Typically, the ratchet mechanism will comprise a ratchet gear with asymmetric teeth, driven by a drive pawl. The pawl is biased into contact with the ratchet by biassing means such as a spring. In normal use, the drive pawl will drive the ratchet gear in one sense during the drive stroke, but due to the shape of the ratchet gear teeth, will ride over the teeth when the pawl is driven in the opposite linear direction on the retraction stroke.

However, we have appreciated that, when the torque wrench is used for loosening bolts, sometimes the bolts will break free suddenly, causing a shock to go through the tool. The sudden release causes the nut, socket, drive and ratchet gear to rotate rapidly. In particular, we have appreciated that this can cause the drive pawl to disengage and flick away from the ratchet gear.

We have appreciated that this flicking motion can cause over-extension of the springs or other biassing means, potentially damaging them. Since the biassing means are vital to the correct functioning of the ratchet mechanism, this can cause reliability problems and premature part failures.

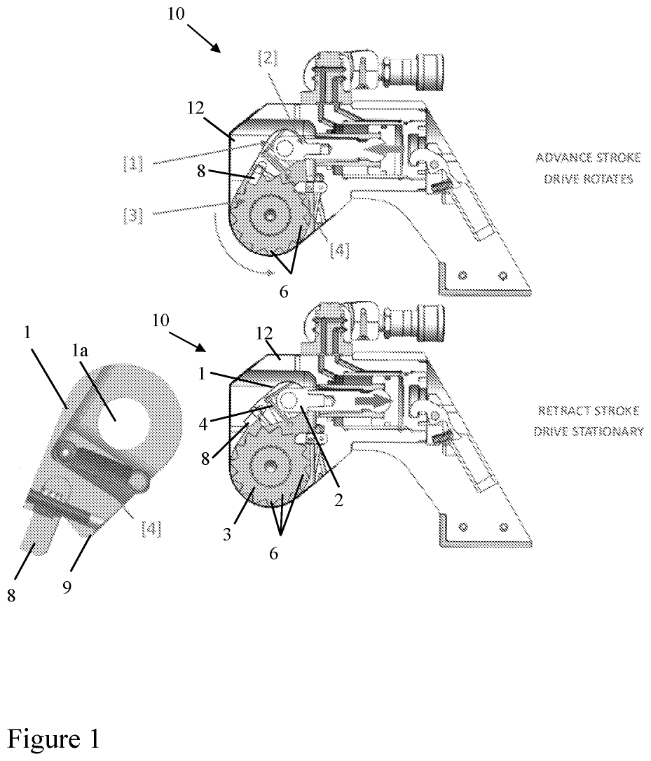

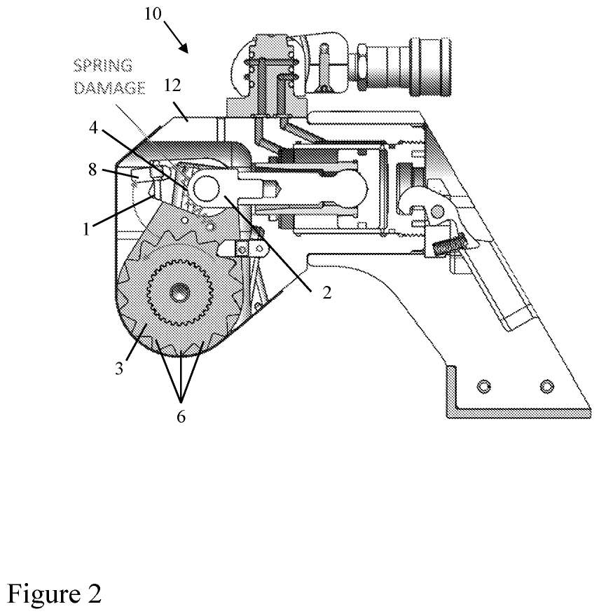

Prior art arrangements are shown in FIG. 1 and FIG. 2.

According to a first aspect of the invention, we provide a hydraulic torque wrench comprising:
a housing;
a drive pawl pivotally mounted in the housing;
a piston rod, configured to be driven and connected to the drive pawl in order to drive the drive pawl;
a ratchet gear configured to be driven for rotation by the drive pawl;
a spring, configured to bias the drive pawl into engagement with the ratchet gear; and
a travel limiter arranged to limit a pivoting travel of the drive pawl away from engagement with the ratchet gear.

As such, by limiting the travel of the drive pawl, we remove the risk that the spring ends up overextended. In a preferred embodiment, the travel limiter limits the travel of the drive pawl such that the spring is not extended past an elastic limit of the spring.

The travel limiter may comprise a first drive plate, wherein the first drive plate includes a first aperture in which is mounted a first pin, wherein the drive pawl includes a first slot which receives the first pin, such that the limit on the pivoting travel of the drive pawl corresponds to the motion of the first pin to ends of the first slot.

The travel limiter may comprise a second drive plate, wherein the first and second drive plates are arranged on opposing sides of the drive pawl, wherein the second drive plate includes a second aperture in which is mounted a second pin, wherein the drive pawl includes a second slot which receives the second pin, such that the limit on the pivoting travel of the drive pawl corresponds to the motion of the second pin to ends of the second slot.

Typically, the ratchet gear comprises teeth and wherein the drive pawl comprises a protruding arm configured to engage the teeth and an aperture configured to allow the drive pawl to be mounted on a shaft, wherein the first slot is positioned on the drive pawl between the protruding arm and the aperture.

The first and/or second slots may follow a part-circular arc, and may have rounded ends.

The hydraulic torque wrench may comprise an inlet for hydraulic fluid, coupled to a piston which is mounted in the housing.

There now follows, by way of example only, description of an embodiment of the invention, described with reference to the accompanying drawings, in which:

FIG. 1 shows a prior art tool arrangement;

FIG. 2 shows spring damage in a prior art tool arrangement;

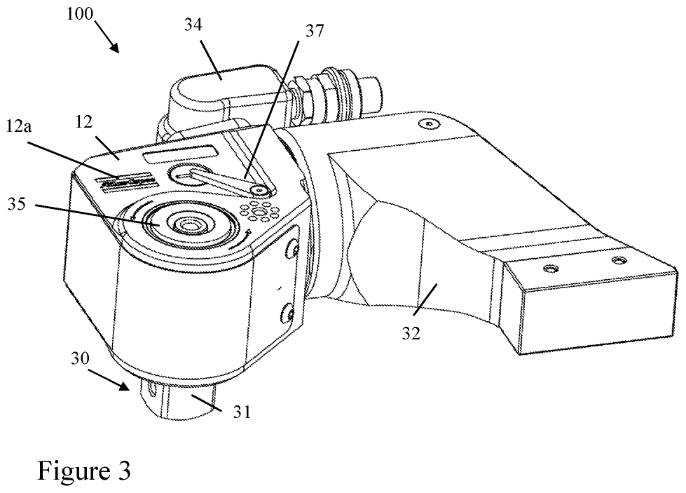

FIG. 3 shows a perspective view of a tool according to examples of the present invention;

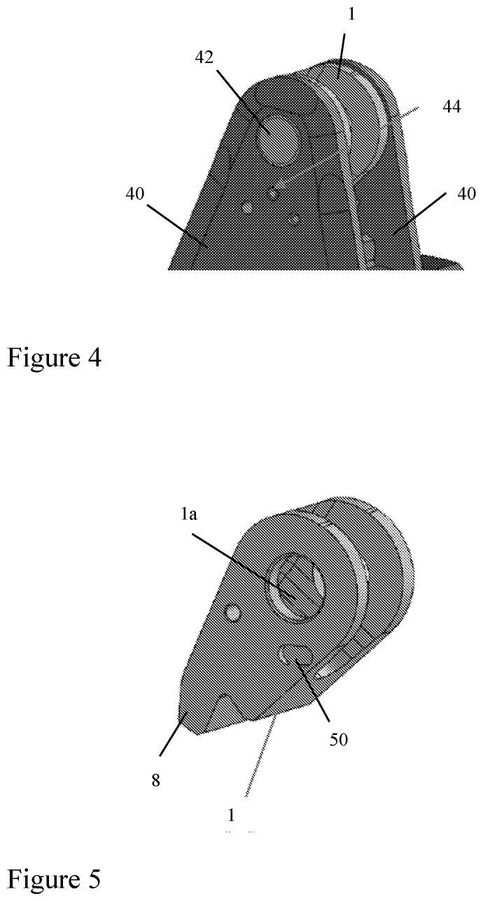

FIG. 4 shows a drive plate according to examples of the present invention;

FIG. 5 shows a drive pawl according to examples of the present invention; and

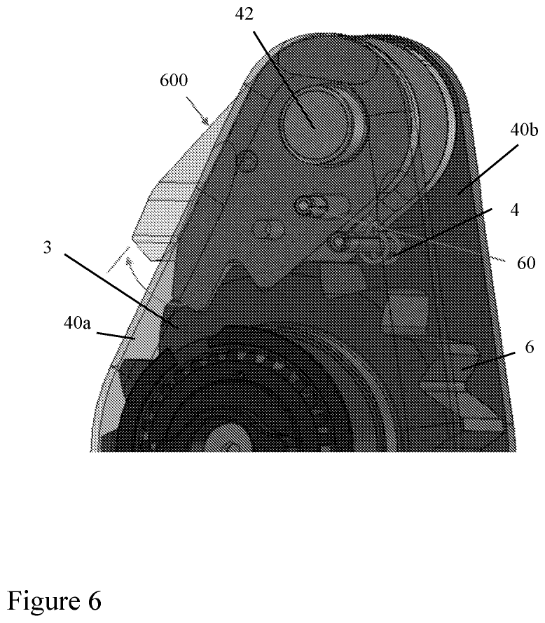

FIG. 6 shows a pawl spring protection mechanism according to examples of the present invention.

FIGS. 1 and 2 show a tool 10 according to the prior art and FIG. 2 indicates a problem with the depicted arrangement: spring damage. FIG. 1 includes two side views of a tool 10, sliced such that internal elements of the tool 10 are visible. The tool 10 may be a torque wrench, for example, used for tightening and/or loosening bolts (depending on how the tool 10 is configured).

The tool 10 may comprise a housing 12, which may encase elements of the tool 10. Each view shows the tool 10 comprising a piston rod 2, a drive pawl 1, a ratchet gear 3 and an extension spring 4. These features may collectively be components of a “drive mechanism”. The extension spring 4 may be replaced with another suitable biassing means.

The piston rod 2 may be configured to be driven hydraulically and the tool assembly 10 may comprise a power source configured to drive the piston rod 2 hydraulically.

In the upper side view, the tool 10 is shown during an advance stroke of the piston rod 2—i.e. when the piston rod 2 is being driven in a direction towards the drive pawl 1. The piston rod 2 may be configured to be connected to the drive pawl 1. The drive pawl 1 may comprise an aperture 1a configured to be mounted onto a shaft of the piston rod 2, connecting the two. The drive pawl 1 may be configured to move in response to motion of the piston rod 2. In the depicted advance stoke, the piston rod 2 may transfer motion to the drive pawl 1 and the motion of the drive pawl 1 may cause the drive pawl 1 to engage the ratchet gear 3 to turn the ratchet gear 3. The ratchet gear 3 may be rotatably mounted within the housing 12 allowing it to be turned by the drive pawl 1; the ratchet gear 3 may include an aperture and the ratchet gear 3 may be mountable on a shaft via the aperture. In the depicted ratchet gear 3, the aperture is central.

The ratchet gear 3 may comprise teeth 6. The teeth 6 may be uniform but asymmetrical—each tooth 6 may include a first sloped edge and a second steeper sloped edge, wherein a sliding part 9 of the drive pawl 1 is configured to slide over the first sloped edge and wherein the second steeper sloped edge prevents that part of the drive pawl 1 from sliding over it. In this way, there is a “forward” direction for the ratchet gear 3 to turn and the drive pawl 1 is configured to drive rotation of the ratchet gear 3 in the forward direction. In FIG. 1, the forward direction is shown with a curved arrow around the ratchet gear 3.

The drive pawl 1 may include a protruding arm 8 configured to engage the ratchet gear 3, for example configured to engage the teeth 6. The protruding arm 8 may be configured to fit between two adjacent teeth 6. As the drive pawl 1 moves, the sliding part 9 guides the drive pawl over the teeth 6 until protruding arm 8 lands in a depression between two adjacent teeth 6.

The protruding arm 8 may be biased into the depression between two adjacent teeth 6 under force from the extension spring 4. One or more springs 4 may be provided to bias the protruding arm 8 into a depression once it has passed over a tip of a tooth 6.

The lower side view of the tool 10 depicts the piston rod 2 retracting. This action of the piston rod 2 may be configured to cause the drive pawl 1 to disengage from the ratchet gear 3. This may cease rotation of the ratchet gear 3 in the forward direction, without the driving force of the drive pawl 1.

FIG. 1 includes a zoomed in view of the drive pawl 1 and shows the extension spring 4. Reliable drive pawl 1 engagement with the teeth 6 may depend on the spring 4 biasing the drive pawl 1 towards the ratchet gear 3 by returning to its neutral position—the extension spring 4 may be expanded as the sliding part 9 passes over the first sloped side of the tooth 6 and/or the tip of a tooth 6, for example, returning to neutral when the protruding arm 8 enters the depression between two adjacent teeth 6.

A pair of extension springs 4 may be provided, each configured to bias the drive pawl 1 towards the ratchet gear 3 and thus to bias the protruding arm 8 into the depression. More than two springs 4 may be provided, for example.

Under normal operations, the spring(s) 4 may work within allowable limits.

FIG. 2 shows the tool 10 with the drive pawl 1 disengaged from the ratchet gear 3. The extension spring 4 has been damaged. Curved arrows show that the ratchet gear 3 has been turned in the forward direction but that the protruding arm 8 is disengaged not only from the depressions between teeth 6 but also the teeth 6 themselves. The drive pawl 1 has rotated too far away from the ratchet gear 3 and has overextended the spring 4.

This may be the result of the tool 10 (which may be a torque wrench) being used to loosen a bolt. The bolt may have broken free suddenly. This may have sent a shock through the tool 10. This sudden release may have caused elements of the tool assembly 10—including the ratchet gear 3—to move in a way that is not desired by the user. The ratchet gear 3 may have spun out of control, meaning that the ratchet gear 3 may have turned rapidly in the forward direction and flicked the drive pawl 1 out of engagement with the ratchet gear 3.

As a result, the extension spring 4 may have over-extended, past the plastic limit for the spring. This may lead to spring damage as shown.

The extension spring 4 (or springs 4) may be vital to the correct functioning of the ratchet gear 3 and drive pawl 1 mechanism. Therefore, spring damage may cause reliability issues and premature part failures.

FIG. 3 shows a tool 100 according to an embodiment of the invention. The depicted tool 100 includes a housing 12 configured to house elements of the tool 100 therein. The tool 100 is a torque wrench; a square drive hydraulic wrench, for example. The tool 100 may include an indication of the product or manufacturer for example, as shown in FIG. 3 (labelled 12a).

The present tool 100 may include any (or all) of the features set out above that are part of the prior art tool 10 and like reference numerals are therefore used throughout for like features.

A drive assembly 30 is mounted on the housing 12. The tool 100 may further comprise a reaction arm 32 and a swivel assembly 34. The reaction arm 32 and swivel assembly 34 is of any type known to the skilled person, and/or one or both may not be present in other embodiments. For example, the swivel assembly 34 may be replaced by a different form of hose connector to allow the tool 100 to be connected to a pump (not shown).

The drive assembly 30 may comprise a drive 31, which may more specifically be a square drive 31 as in the embodiment shown. Different drives 31 may be used in other embodiments. The tool 100 may comprise a drive retainer 35 configured to prevent the drive 31 from sliding out of the tool 100.

The tool 100 may also include various other features standard in the art, such as a reaction pawl within the tool 100 to provide an anti-backlash mechanism, and optionally also a reaction pawl lever 37 as shown in FIG. 3 that may be used to disengage the reaction pawl from the ratchet gear 3 if the tool 100 becomes locked onto the object(s) to which it was being used to apply a torque.

The tool 100 may comprise the drive pawl 1, the piston rod 2 and the ratchet gear 3 discussed above, as well as all of the associated features.

FIG. 4 shows a section of the drive pawl 1 of the present tool 100. In order to prevent spring over-extension and subsequent damage, the drive pawl 1 has an aperture configured to receive a retaining pin 60 (see FIG. 6). The retaining pin 60 is generally cylindrical, without straight edges. The tool 100 may include drive plates 40. The drive pawl 1 is arranged between two drive plates 40 and mounted on a shaft 42 (for example via the aperture 1a). The shaft 42 is configured to be connected to the piston rod 2 and the two drive plates 40 may sit either side of the connection to the piston rod 2. Each drive plate 40 has an aperture 44 configured to receive a retaining pin 60.

The drive pawl 1 may comprise a slot 50. The slot 50 is configured to receive a retaining pin 60. The retaining pin 60 is smaller in size than the slot 50 such that it has some freedom to move within the slot 50. In this way, the retaining pin 60 being in the slot 50 does not prevent or hinder normal movements of the drive pawl 1. By normal movements, this includes allowing the drive pawl 1 to skip over teeth 6 of the ratchet gear 3 and for the protruding arm 8 to fall into depressions between teeth 6.

The slot 50 follows a part-circular arc, coaxial with the shaft 42 with rounded edges, to prevent the retaining pin 60 arranged therein from wearing down sharp corners in use and likewise to prevent damage to the retaining pin 60 that may be caused by sharp corners.

The slot 50 is arranged on the drive pawl 1 between the aperture 1a and the protruding arm 8, for example.

In the tool 100, the same retaining pin 60 may pass first through a first drive plate 40a, then into the slot 50. In this way, the motion of the drive pawl 1 may be restricted to whatever is permitted by the retaining pin 60 in the slot 50, limited by being fixed to the first drive plate 40a.

The drive plates 40 are arranged in the housing 12 to cover at least part of the ratchet gear 3 in use. For example, FIG. 6 shows a view of the ratchet gear 3 and drive plates 40 in which the first drive plate 40a is shown translucent to reveal that the ratchet gear 3 is at least partially covered below. In order to prevent shock damage to the spring due to an excessive disengagement of the drive pawl 1 from the ratchet gear 3, a retaining pin 60 is inserted through an aperture 44 that is arranged adjacent but spaced apart from a region of the first drive plate 40a that covers the ratchet gear 3. If the retaining pin 60 were inserted closer to the ratchet gear 3, then the drive pawl 1 may be prevented from disengaging in any capacity from the ratchet gear 3—which is not desirable. FIG. 6 shows a region 600 in shadow, depicting an example range of motion of the drive pawl 1 when the retaining pin 60 is inserted through the first drive plate 40a and the slot 50. A curved arrow in FIG. 6 shows the direction in which the drive pawl 1 may be permitted to swing away from the ratchet gear 3 within the range 600.

A second retaining pin 60 is inserted into an aperture 44 through a second drive plate 40b. The second drive plate 40b may have all of the features of the first drive plate 40a and is arranged on or near the opposite side of the shaft 42 from the first drive plate 40a such that the drive pawl 1 is arranged between the drive plates 40a, 40b. The second retaining pin 60 is inserted substantially parallel to the first retaining pin 60. The first and second drive plates 40a, 40b include apertures 44 in substantially the same position.

The drive pawl 1 may include a second slot 50, configured to receive the second retaining pin 60. The second slot 50 is configured in the same way as the first slot 50 to restrict motion of the drive pawl 1 by allowing the retaining pin 60 only restricted movement within the slot 50.

Providing a pin 60 in each drive plate 40a, 40b may prevent one part of the drive pawl 1—the part defining the slot 50 and receiving the retaining pin 60—from wearing down more quickly than another part without a slot 50/pin 60. Each pin 60 may also share the load of the task and therefore may not need to be as robust as if only one pin 60 were provided, for example. In addition, having a pin 60 on either side of the drive pawl 1 may prevent the drive pawl 1 from potentially twisting based on the action of a single pin 60 on one side only, in a shock event.

The or each retaining pin 60 may have a uniform diameter along its whole length or may taper or otherwise have a variable diameter. For example, the pin 60 may have a mushroomed end or otherwise larger part, which has a diameter exceeding that of the aperture 44, to prevent the pin 60 from passing completely through the aperture 44.

A cap or other stopper is added to the pin 60 once fed through the aperture 44 and/or slot 50 to prevent the pin 60 from exiting the aperture 44 and/or slot 50. This may be removable and replaceable.

The retaining pins 60 may arrest the movement of the drive pawl 1 when shock loads are present and therefore protect the or each extension spring 4.

The first and/or second drive plate 40a, 40b may comprise one or more additional apertures to receive additional retaining pins 60 accordingly. The slot 50 may be configured to receive more than one pin 60, or the drive pawl 1 may include more than one slot 50 to accommodate multiple pins 60, as desired. Each slot 50 may be suitably sized and/or shaped to work together to define the range 600 of movement of the drive pawl 1.

In use, a single retaining pin 60 may be inserted into a drive plate 40 that has multiple apertures configured to receive the pin 60, based on the user's desired position of the retaining pin 60 or desired range 600 of motion of the drive pawl 1.

In any event, each retaining pin 60 may have any or all of the features described herein of the first retaining pin 60, whether there be multiple pins 60 though one drive plate 40 or one or more pins 60 inserted into each drive plate 40a, 40b.

1. A hydraulic torque wrench comprising:
a housing;
a drive pawl pivotally mounted in the housing;
a piston rod, configured to be driven and connected to the drive pawl in order to drive the drive pawl;
a ratchet gear configured to be driven for rotation by the drive pawl;
a spring, configured to bias the drive pawl into engagement with the ratchet gear; and
a travel limiter arranged to limit a pivoting travel of the drive pawl away from engagement with the ratchet gear.

2. The hydraulic torque wrench of claim 1, in which the travel limiter limits the travel of the drive pawl such that the spring is not extended past an elastic limit of the spring.

3. The hydraulic torque wrench of claim 1, in which the travel limiter comprises a first drive plate, wherein the first drive plate includes a first aperture in which is mounted a first pin, wherein the drive pawl includes a first slot which receives the first pin, such that the limit on the pivoting travel of the drive pawl corresponds to the motion of the first pin to ends of the first slot.

4. The hydraulic torque wrench of claim 3, in which the travel limiter comprises a second drive plate, wherein the first and second drive plates are arranged on opposing sides of the drive pawl, wherein the second drive plate includes a second aperture in which is mounted a second pin, wherein the drive pawl includes a second slot which receives the second pin, such that the limit on the pivoting travel of the drive pawl corresponds to the motion of the second pin to ends of the second slot.

5. The hydraulic torque wrench of claim 3, wherein the ratchet gear comprises teeth and wherein the drive pawl comprises a protruding arm configured to engage the teeth and an aperture configured to allow the drive pawl to be mounted on a shaft, wherein the first slot is positioned on the drive pawl between the protruding arm and the aperture.

6. The hydraulic torque wrench of claim 3, wherein the first and/or second slots follow a part-circular arc.

7. The hydraulic torque wrench of claim 1, comprising an inlet for hydraulic fluid, coupled to a piston which is mounted in the housing.
